(19) United States
(12) Patent Application Publication
(10) Pub. No.: US 2025/0038190 A1
(43) Pub. Date: Jan. 30, 2025

(54) VANADIUM OXIDE-BASED NEGATIVE ELECTRODE MATERIAL FOR ZINC-ION BATTERY, METHOD FOR PRODUCING SAME, AND ZINC-ION BATTERY INCLUDING SAME

(71) Applicant: lNDUSTRY-ACADEMIC COOPERATION FOUNDATION GYEONGSANG NATIONAL UNIVERSITY, Jinju-si (KR)

(72) Inventors: Geon Hyoung An, Jinju-si (KR); Geun Yoo, Yecheon-eup (KR)

(21) Appl. No.: 18/833,833

(22) PCT Filed: Jan. 16, 2023
(86) PCT No.: PCT/KR2023/000726

§ 371 Date: Jul. 26, 2024

(30) Foreign Application Priority Data
Mar. 29, 2022 (KR) 10-2022-0038787

(51) Int. Cl. H01M 4/48; H01M 4/02; H01M 4/04; H01M 4/66; H01M 10/054; H01M 10/0562; H01M 10/44

(52) U.S. Cl. CPC H01M 4/48; H01M 4/0404; H01M 4/661; H01M 10/054; H01M 10/0562; H01M 10/44; H01M 2004/021; H01M 2004/028

(57) ABSTRACT

The present invention pertains to a vanadium oxide-based cathode material for a zinc-ion battery, a method for producing same, and a zinc-ion battery including same. The vanadium oxide-based cathode material for a zinc-ion battery according to an embodiment of the present invention comprises: oxygen vacancy (Vₒ)-containing vanadium oxide nanoparticles; and water (H₂O) intercalated in the lattice of the oxygen vacancy-containing vanadium oxide nanoparticles.

### TECHNICAL FIELD

The present disclosure relates to a vanadium oxide-based cathode material for a zinc-ion battery, a method of preparing the same, and a zinc-ion battery including the same.

### BACKGROUND ART

Due to the increased environmental concerns and energy crisis over the use of fossil fuels, renewable energy sources, such as solar power and wind, that may generate electrical energy have attracted significant attention. However, the output of solar power and wind is regularly unstable and inconsistent due to various environmental and geographical conditions. To efficiently utilize variable renewable energy and clean energy, large-scale energy storage systems (ESS) that may achieve high energy/power density and good cycling stability are needed.

Lithium-ion batteries (LIBs) are the most widely used energy storage devices. However, the use of lithium has the disadvantages of low safety, limited supply, uneven distribution, and high cost. In this regard, rechargeable batteries, especially water-based batteries based on Earth-abundant Al, Mg, and Zn, are attracting attention due to their low cost and use of safe aqueous electrolytes. Among them, zinc-ion batteries (ZIBs) have emerged as promising alternative to LIBs due to low cost, non-toxicity, and high theoretical specific capacity of 820 mA h g⁻¹. Nevertheless, ZIB has limitations as a cathode material with limited capacity and low rate performance.

### DISCLOSURE OF THE INVENTION

### Technical Goals

To solve the problems described above, the present disclosure provides a vanadium oxide-based cathode material for a zinc-ion battery with a stable ion diffusion process, an increased number of active sites, enhanced electrical conductivity, and improved wettability, a method of preparing the same, and a zinc-ion battery including the same.

However, goals to be achieved are not limited to those described above, and other goals not mentioned above are clearly understood by one of ordinary skill in the art from the following description.

### Technical Solutions

A vanadium oxide-based cathode material for a zinc-ion battery according to an embodiment of the present disclosure includes nanoparticles of oxygen vacancy (Vₒ) vanadium oxide, and water (H₂O) intercalated into lattices of the nanoparticles of the oxygen vacancy vanadium oxide.

In an embodiment, an interface of the vanadium oxide may be split from bare vanadium oxide.

In an embodiment, the bare vanadium oxide may have a diameter of 0.1 μm (micrometers) to 5 μm.

In an embodiment, the split vanadium oxide may have a thickness of 20 nm (nanometers) or less.

In an embodiment, the split vanadium oxide may have an interlayer gap of 0.1 nm to 10 nm.

In an embodiment, the oxygen vacancy vanadium oxide may be vanadium oxide including interfacial oxygen vacancies.

In an embodiment, the nanoparticles of the vanadium oxide may include one or more selected from a group consisting of V₂O₅, V₂O₃, V₃O₇, V₄O₇, V₅O₉, V₆O₁₁, V₆O₁₃, and V₇O₁₃.

A method of preparing a vanadium oxide-based cathode material for a zinc-ion battery according to another embodiment of the present disclosure includes coating a metal foil with vanadium oxide nanoparticles, and preparing water (H₂O)-intercalated nano-sized split vanadium oxide by causing a charging and discharging reaction of a battery including the metal foil coated with the vanadium oxide nanoparticles as a working electrode in a full-cell condition.

In an embodiment, the metal foil may include at least one selected from a group consisting of stainless steel (SUS), copper (Cu), nickel (Ni), iron (Fe), chromium (Cr), and cobalt (Co).

In an embodiment, the battery may include a Zn counter electrode and a ZnSO₄ electrolyte.

In an embodiment, the charging and discharging reaction may be performed by a charging and discharging test at a current density of 1 A g⁻¹ of 0.1 A g⁻¹ during 30 cycles to 100 cycles.

In an embodiment, the method may further include, after preparing the water (H₂O)-intercalated nano-sized split vanadium oxide, separating the water (H₂O)-intercalated nano-sized split vanadium oxide from the metal foil, forming a mixture by mixing a pulverized powder of the separated water (H₂O)-intercalated nano-sized split vanadium oxide with a binder and a conductive material, and forming the mixture on a current collector.

A zinc-secondary battery according to still another embodiment of the present disclosure includes a cathode including the vanadium oxide-based cathode material for the zinc-ion battery of an embodiment of the present disclosure or the vanadium oxide-based cathode material for the zinc-ion battery prepared by the method of preparing vanadium oxide-based cathode material for the zinc-ion battery, an anode for the zinc-ion battery, a separator interposed between the cathode including the vanadium oxide-based cathode material for the zinc-ion battery and the anode for the zinc-ion battery, and an electrolyte.

### Effects of the Invention

A vanadium oxide-based cathode material for a zinc-ion battery according to an embodiment of the present disclosure is split by a process, in which an interface of nanoparticles of vanadium oxide is intercalated into water (H₂O), and oxygen is used due to the intercalation of water (H₂O) into the interface of the nanoparticles of the vanadium oxide to form interfacial oxygen vacancies (Vₒ). This may act as open channels for insertion/desertion of zinc ions. Accordingly, it is possible to provide high-speed performance and cycling stability as a charge diffusion rate and electrical conductivity are improved. Therefore, it may help improve an engineering potential of the application of a zinc-ion storage mechanism in a next-generation energy storage device.

By a method of preparing a vanadium oxide-based cathode material for a zinc-ion battery according to an embodiment of the present disclosure, it is possible to improve diffusion ability of zinc-ions due to lattices expanded when water (H₂O) is intercalated into nanoparticles of the vanadium oxide, and to improve electrical conductivity due to the presence of oxygen vacancies. Based on this, an electrochemical reaction area may be increased to improve energy storage performance and life stability.

A zinc-ion battery according to an embodiment of the present disclosure may improve zinc ion diffusion ability due to lattices expanded due to intercalation of water (H₂O) to nanoparticles of vanadium oxide, improve electrical conductivity due to oxygen vacancies, and improve energy storage performance and life stability with an increase of an electrochemical reaction area.

### BRIEF DESCRIPTION OF DRAWINGS

FIG. 1 is a schematic view of a vanadium oxide-based cathode material for a zinc-ion battery according to an embodiment of the present disclosure.

FIG. 2 is a diagram schematically illustrating (a) a Zn-ion battery (ZIB) of the related art, (b) an aging process of a ZIB cathode, (c) a structural modification of a vanadium oxide (V₂O₅) cathode with increasing capacity during the aging process, and (d) poor stability of a ZIB cathode after the aging process.

FIG. 3 is a schematic diagram of (a) an electrochemical activation process, (b) fabrication of a stabled cathode, and (c) a ZIB assembled using the stabled cathode without an aging process according to an embodiment of the present disclosure.

FIG. 4 illustrates a scanning electron microscopy (SEM) image and an enlarged SEM image of bare V₂O₅ (a and b), a SEM image and an enlarged SEM image of nano-sized split V₂O₅ with H₂O-intercalated interfaces (NSVOHI, c and d); high-magnification transmission electron microscopy (TEM) images of the bare V₂O₅ (e and f), and high-magnification TEM images of NSVOHI (g and h).

FIGS. 5A and 5B illustrates, for bare V₂O₅ and NSVOHI according to an embodiment of the present disclosure, (a) X-ray diffraction (XRD) patterns, (b) enlarged XRD patterns in a range of 20.2° to 20.5°, (c) plots of calculated lattice parameters, (d) Williamson-Hall plots, (e) V 2p_{3/2} and (f) C 1 s X-ray photoelectron spectroscopy (XPS) results, (g) electrical conductivity, (h) thermogravimetric analysis (TGA) curves, (i) differential scanning calorimetry (DSC) curves, (j) Barrett-Joyner-Halenda (BJH) results, and (k) contact angle measurement of V₂O₅ and (i) contact angle measurement of NSVOHI.

FIG. 6 illustrates kinetic analyses of bare V₂O₅ and NSVOHI electrodes according to an embodiment of the present disclosure: (a) Nyquist plots; (b) Bode plots; (c) a correlation between Zᵣₑₐₗ and ω^{-1/2}; (d) a Zn-ion diffusion coefficient, (e) CV curves at scan rates of 0.1 to 1.0 mVs⁻¹ of the NSVOHI electrodes; (f) determination of b values of four peak currents according to a slope of log (i) versus log (v) in the CV curves; (g) capacitive behaviors and intercalation reaction contributions at 1.0 mVs⁻¹; and (h) normalized contribution ratios of capacitive storage to whole intercalation capacity at different scan rates.

FIG. 7 illustrates electrochemical performance of ZIBs fabricated using bare V₂O₅ and NSVOHI electrodes according to an embodiment of the present disclosure: (a) charge-discharge curves; (b) rate performances; (c) comparison of the rate performances of the fabricated ZIB with those of previously-reported ZIBs; (d) cycling stability; (e) Ragone plot comparing power and energy density of a ZIB fabricated using the NSVOHI electrode with power and energy density of a previously-reported energy storage device.

FIG. 8 illustrates three-dimensional (3D) surface images and resultant height plots of (a and b) an initial bare V₂O₅ electrode; (c and d) a cycled bare V₂O₅ electrode; (e and f) an initial NSVOHI electrode; and (g and h) a cycled NSVOHI electrode according to an embodiment of the present disclosure.

FIG. 9 is diagrams illustrating reversibility of bare V₂O₅ and NSVOHI electrodes after a cycling test: cross-sectional SEM images and energy-dispersive X-ray spectroscopy (EDS) mapping of (a) a bare V₂O₅ electrode and (b) a NSVOHI electrode; (c) a ratio of Zn to V obtained from the EDS mapping.

FIG. 10 is diagrams illustrating energy storage performance of an all-solid-state ZIBs consisting of a NSVOHI electrode and a gel electrolyte: (a) a schematic view of an all-solid-state ZIB structure; (b) Nyquist plots; (c) rate performance; (d) cycling stability; and (e) a Ragone plot comparing power and energy density of a ZIB fabricated using a NSVOHI electrode with power and energy density of a previously-reported all-solid-state energy storage devices.

FIG. 11 illustrates investigation of practical application of an NSVOHI electrode according to an embodiment of the present disclosure: (a) photographs showing voltage conditions of a Bluetooth device, a microcontroller, and a smart phone connected to an electrode in straight, folded, and cut states even under water, (b) charge-discharge curves of five devices connected in series, and (c) a photograph showing an operation of a light emitting diode by fabricated ZIBs.

FIG. 12 illustrates schematic diagrams showing a synergetic effect of a stable ion diffusion process, an increased number of active sites, enhanced electrical conductivity, and improved wettability of a NSVOHI electrode on its the electrochemical performance.

### BEST MODE FOR CARRYING OUT THE INVENTION

Hereinafter, embodiments will be described in detail with reference to the accompanying drawings. However, various alterations and modifications may be made to the embodiments and thus, the scope of the disclosure is not limited or restricted to the embodiments. The equivalents should be understood to include all changes, equivalents, and replacements within the idea and the technical scope of the disclosure.

The terminology used herein is for the purpose of describing particular embodiments only and is not to be limiting of the embodiments. The singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the embodiments with reference to the accompanying drawings, like reference numerals refer to like components and a repeated description related thereto will be omitted. In the description of embodiments, detailed description of well-known related structures or functions will be omitted when it is deemed that such description will cause ambiguous interpretation of the present disclosure.

In addition, the terms first, second, A, and B may be used to describe constituent elements of the embodiments. These terms are used only for the purpose of discriminating one component from another component, and the nature, the sequences, or the orders of the components are not limited by the terms.

A component, which has the same common function as a component included in any one embodiment, will be described by using the same name in other embodiments. Unless disclosed to the contrary, the description of any one embodiment may be applied to other embodiments, and the specific description of the repeated configuration will be omitted.

Hereinafter, a vanadium oxide-based cathode material for a zinc-ion battery, a method of preparing the same, and a zinc-ion battery including the same of the present disclosure will be described in detail. However, the present disclosure is not limited to such an embodiment and drawings.

A vanadium oxide-based cathode material for a zinc-ion battery according to an embodiment of the present disclosure includes nanoparticles of oxygen vacancy (Vₒ) vanadium oxide, and water (H₂O) intercalated into lattices of the nanoparticles of the oxygen vacancy vanadium oxide.

The vanadium oxide-based cathode material for a zinc-ion battery according to the present disclosure has a stable ion diffusion process, an increased number of active sites, enhanced electrical conductivity, and improved wettability.

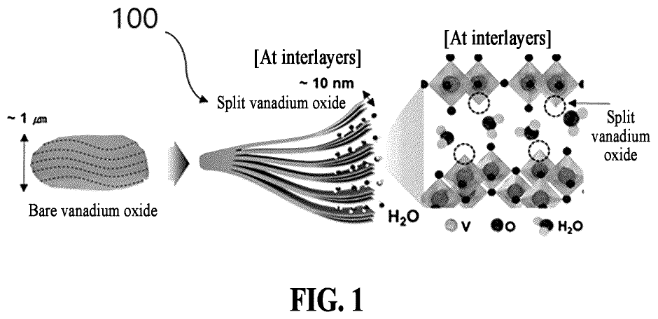

FIG. 1 is a schematic view of a vanadium oxide-based cathode material for a zinc-ion battery according to an embodiment of the present disclosure.

Referring to FIG. 1, in a vanadium oxide-based cathode material for a zinc-ion battery according to an embodiment of the present disclosure, water (H₂O) may be intercalated between lattices of nano-sized split vanadium oxide.

In an embodiment, as shown in the drawing, an interface of the vanadium oxide may be split from bare vanadium oxide.

In an embodiment, the base vanadium oxide may have a diameter of 0.1 μm to 5 μm; 0.1 μm to 3 μm; 0.1 μm to 1 μm; 1 μm to 5 μm; and 3 μm to 5 μm.

In an embodiment, the split vanadium oxide may have a thickness of 20 nm or less; 18 nm or less; 16 nm or less; 14 nm or less; 12 nm or less; or 10 nm or less.

Desirably, the split vanadium oxide may have a thickness of 10 nm to 15 nm.

In an embodiment, the split vanadium oxide may have an interlayer gap of 0.1 nm to 10 nm; 0.1 nm to 8 nm; 0.1 nm to 5 nm; 0.1 nm to 3 nm; 0.1 nm to 1 nm; 1 nm to 10 nm; 1 nm to 8 nm; 1 nm to 5 nm; 1 nm to 3 nm; 3 nm to 10 nm; 3 nm to 8 nm; 3 nm to 5 nm; 5 nm to 10 nm; 5 nm to 8 nm; or 8 nm to 10 nm.

In an embodiment, as shown in the drawing, the oxygen vacancy vanadium oxide may be vanadium oxide including interfacial oxygen vacancies.

In an embodiment, the nanoparticles of the vanadium oxide may include one or more selected from a group consisting of V₂O₅, V₂O₃, V₃O₇, V₄O₇, V₅O₉, V₆O₁₁, V₆O₁₃, and V₇O₁₃.

Desirably, the nanoparticles of the vanadium oxide may be V₂O₅.

The vanadium oxide-based cathode material for the zinc-ion battery according to an embodiment of the present disclosure may be nano-sized spilt V₂O₅ with H₂O-intercalated interfaces (NSVOHI).

The vanadium oxide-based cathode material for the zinc-ion battery according to an embodiment of the present disclosure is split by a process, in which an interface of nanoparticles of vanadium oxide is intercalated into water (H₂O), and oxygen is used due to the intercalation of water (H₂O) into the interface of the nanoparticles of the vanadium oxide to form interfacial oxygen vacancies (Vₒ). This may act as open channels for insertion/desertion of zinc ions. Accordingly, it is possible to provide high-speed performance and cycling stability as a charge diffusion rate and electrical conductivity are improved. Therefore, it may help improve an engineering potential of the application of a zinc-ion storage mechanism in a next-generation energy storage device.

A method of preparing a vanadium oxide-based cathode material for a zinc-ion battery according to another embodiment of the present disclosure includes coating a metal foil with vanadium oxide nanoparticles; and preparing water (H₂O)-intercalated nano-sized split vanadium oxide by causing a charging and discharging reaction of a battery including the metal foil coated with the vanadium oxide nanoparticles as a working electrode in a full-cell condition.

In the method of preparing the vanadium oxide-based cathode material for the zinc-ion battery of the present disclosure, water (H₂O) may be intercalated into lattices of vanadium oxide nanoparticles using an electrochemical method. As water (H₂O) is intercalated into lattices of vanadium oxide nanoparticles, the lattices may be expanded, thereby controlling a structure advantageous for zinc ions.

In an embodiment, the metal foil may include at least one selected from a group consisting of stainless steel (SUS), copper (Cu), nickel (Ni), iron (Fe), chromium (Cr), and cobalt (Co).

Desirably, the metal foil may be stainless steel (SUS).

In an embodiment, the battery may include a Zn counter electrode and a ZnSO₄ electrolyte.

In an embodiment, the charging and discharging reaction may be performed by a charging and discharging test at a current density of 1 A g⁻¹ of 0.1 A g⁻¹; 0.8 A g⁻¹ of 0.1 A g⁻¹; or 0.5 A g⁻¹ of 0.1 A g⁻¹ during 30 cycles to 100 cycles; 30 cycles to 80 cycles; 30 cycles to 50 cycles; 50 cycles to 100 cycles; or 80 cycles to 100 cycles.

In an embodiment, the method may further include, after preparing the water (H₂O)-intercalated nano-sized split vanadium oxide, separating the water (H₂O)-intercalated nano-sized split vanadium oxide from the metal foil; forming a mixture by mixing a pulverized powder of the separated water (H₂O)-intercalated nano-sized split vanadium oxide with a binder and a conductive material; and forming the mixture on a current collector.

In an embodiment, the separating of the water (H₂O)-intercalated nano-sized split vanadium oxide from the metal foil may be performed by a peel-off process.

In an embodiment, the forming of the mixture by mixing a pulverized powder of the separated water (H₂O)-intercalated nano-sized split vanadium oxide with a binder and a conductive material may include mixing the pulverized powder of the separated water (H₂O)-intercalated nano-sized split vanadium oxide with a conductive material such as graphite fine particles, carbon black such as acetylene black and Ketjen black, or needle coke, and a binder.

In an embodiment, the forming of the mixture on a current collector may include forming a cathode by coating the mixture on the current collector.

In an embodiment, the current collector may be graphite.

By the method of preparing the vanadium oxide-based cathode material for the zinc-ion battery according to an embodiment of the present disclosure, it is possible to improve diffusion ability of zinc-ions due to lattices expanded when water (H₂O) is intercalated into lattices of nanoparticles of the vanadium oxide, and to improve electrical conductivity due to the presence of oxygen vacancies. Based on this, an electrochemical reaction area may be increased to improve energy storage performance and life stability.

A zinc-secondary battery according to still another embodiment of the present disclosure includes a cathode including the vanadium oxide-based cathode material for the zinc-ion battery according to an embodiment of the present disclosure or the vanadium oxide-based cathode material for the zinc-ion battery prepared by the method of preparing the vanadium oxide-based cathode material for the zinc-ion battery according to another embodiment of the present disclosure; an anode for the zinc-ion battery; a separator interposed between the vanadium oxide-based cathode for the zinc-ion battery the anode for the zinc-ion battery; and an electrolyte.

In an embodiment, the vanadium oxide-based cathode material for the zinc-ion battery may include the vanadium oxide-based cathode material for the zinc-ion battery according to an embodiment of the present disclosure or the vanadium oxide-based cathode material for the zinc-ion battery prepared by the method of preparing the vanadium oxide-based cathode material for the zinc-ion battery according to another embodiment of the present disclosure.

In an embodiment, for the anode for the zinc-ion battery, an anode material may be obtained by mixing an anode active material, a conductive material, and a binder.

In an embodiment, the conductive material may include at least one selected from a group consisting of natural graphite, artificial graphite, Ketjen black, cokes, carbon black, carbon nanotubes, and graphene.

In an embodiment, the binder may include at least one selected from a group consisting of thermoplastic resins, such as fluororesins such as polyvinylidene fluoride, polytetrafluoroethylene, ethylene tetrafluoride, a vinylidene fluoride-based copolymer, and propylene hexafluoride; and polyolefin resins such as polyethylene and polypropylene.

In an embodiment, the anode material may be coated on a cathode current collector to form an anode. The cathode current collector may be a conductive body such as Al, Ni, or stainless steel. In the coating of the anode material on the cathode current collector, a method of obtaining a paste using pressure molding or an organic solvent, then coating this paste on a current collector and pressing to fix it may be used.

In an embodiment, the organic solvent may include amines such as N,N-dimethylaminopropylamine and diethyltriamine; ethers such as ethylene oxide and tetrahydrofuran; ketones such as methyl ethyl ketone; esters such as methyl acetate; and aprotic polar solvents such as dimethylacetamide and N-methyl-2-pyrrolidone.

In an embodiment, the coating of the paste on the cathode current collector, for example may be performed by using a gravure coating method, a slit die coating method, a knife coating method, or a spray coating method.

In an embodiment, a separator may be disposed between the vanadium oxide-based cathode material for the zinc-ion battery and the anode for the zinc-ion battery. Such a separator may include at least one selected from a group consisting of a porous film, non-woven fabric, and woven fabric formed of materials such as a polyolefin resin such as polyethylene and polypropylene, fluororesin, and a nitrogen-containing aromatic polymer.

In an embodiment, a thickness of the separator is desirably thinner as long as a mechanical strength is maintained from viewpoints that a volumetric energy density of a battery increases and internal resistance decreases.

In an embodiment, the thickness of the separator may be, for example, about 5 μm to 200 μm, and desirably, 5 μm to 40 μm.

In an embodiment, the electrolyte may include a zinc salt. It may be desirably Zn(CF₃SO₃)₂.

The zinc-ion battery according to an embodiment of the present disclosure may improve diffusion ability of zinc-ions due to lattices expanded when water (H₂O) is intercalated into nanoparticles of the vanadium oxide, improve electrical conductivity due to the oxygen vacancies, and improve energy storage performance and life stability with an increase of an electrochemical reaction area.

Hereinafter, the present disclosure will be described in more detail with reference to examples and comparative examples.

However, the following examples are only for illustrating the present disclosure, and the content of the present disclosure is not limited to the following examples.

In an embodiment of the present disclosure, to prepare a stable ZIB cathode, H₂O was intercalated into V₂O₅ interlayers via an electrochemical activation process using a two-electrode system. A paste consisting of a V₂O₅ powder and polyvinylidene difluoride (PVDF) (a mass ratio of 7:3) in N-Methyl 2-pyrrolidine (NMP) was casted on a stainless steel foil, after which the foil was dried and used as a working electrode. A Zn foil and 2 M zinc sulfate (ZnSO₄) were used as a counter electrode and an electrolyte, respectively. Next, the electrochemical activation process was conducted by performing a charge/discharge process in a voltage range from 0.4 V to 1.6 V at a current density of 0.5 A g⁻¹ for 60 cycles. Subsequently, NSVOHI, which was used as the cathode, was separated from the stainless steel foil and washed by NMP.

The element of bare V₂O₅ and NSVOHI after an electrochemical activation process was investigated using inductively coupled plasma-mass spectrometry (ICP-MS). The morphology of V₂O₅ and NSVOHI was investigated using scanning electron microscopy (SEM) and transmission electron microscopy (TEM). The crystal nature and chemical bonding states of the bare V₂O₅ and NSVOHI were investigated using X-ray diffraction (XRD) and X-ray photoelectron spectroscopy (XPS). The presence of oxygen vacancies for of the bare V₂O₅ and NSVOHI was identified by electron paramagnetic resonance (EPR) spectroscopy. The electrical conductivity of the prepared cathode was measured using Hall effect measurement. A chemical composition of the bare V₂O₅ and NSVOHI was investigated using thermogravimetric analysis (TGA) under ambient atmosphere in a temperature range from 100 to 400° C. In addition, differential scanning calorimetry (DSC) analysis was performed in air. A pore volume and a specific surface area of the cathode material were determined via the Barrett-Joyner-Halenda (BJH) and Brunauer-Emmett-Teller (BET) method using nitrogen adsorption and desorption.

The wettability of the electrolyte at the electrode/electrolyte interface was examined using contact angle measurement. The electrochemical behavior and energy storage performance were evaluated using coin-type cells composed of a NSVOHI cathode, a Zn foil anode, and a 3 M zinc trifluoromethanesulfonate (Zn(CF₃SO₃)₂) electrolyte. The cathode was prepared by coating a slurry mixed with NSVOHI as an active material, PVDF as a binder, and Ketjen Black as a conductive material (a mass ratio of 7:2:1) in NMP on a current collector, after which the mixture was dried at 80° C. Subsequently, electrochemical impedance spectroscopy (EIS) was performed by applying an AC signal of 5 mV in a frequency range from 10⁵ to 10⁻² Hz. An electrochemical reaction of the electrode was investigated by examining their CV curves, which was obtained using a potentiostat/galvanostat at a scan rate of 0.1 to 1.0 mV s⁻¹. The rate capability of the cell was tested at current densities of 0.1, 0.3, 0.5, 0.7, 1.0, 1.3, 1.5, 1.7, and 2.0 A g⁻¹. The cycling stability was investigated at a current density of 1.3 and 5.0 A g⁻¹ for 200 and 1,000 cycles, respectively. After the cycling tests, an electrode structure was observed using a three-dimensional (3D) surface confocal laser scanning microscope (3D surface microscope) and a cross-sectional scanning electron microscope equipped with energy-dispersive X-ray spectroscopy (EDS). Further, an all-solid-state ZIB was assembled using a gel electrolyte consisting of 3.3 g Zn(CF₃SO₃)₂ and 1.45 g polyvinyl alcohol (PVA, M_{w}: 89,000 to 98,000) in 3 mL of distilled water, with NSVOHI as an active material, Zn foil as an anode, and cellulose paper as a separator. The battery performance was evaluated using rate performance measurements at current densities of 0.3, 0.5, 1.0, 1.5, 2.0, and 0.3 A g⁻¹ and a cycling stability test at a current density of 0.5 A g⁻¹ for up to 100 cycles.

### Results and Discussion

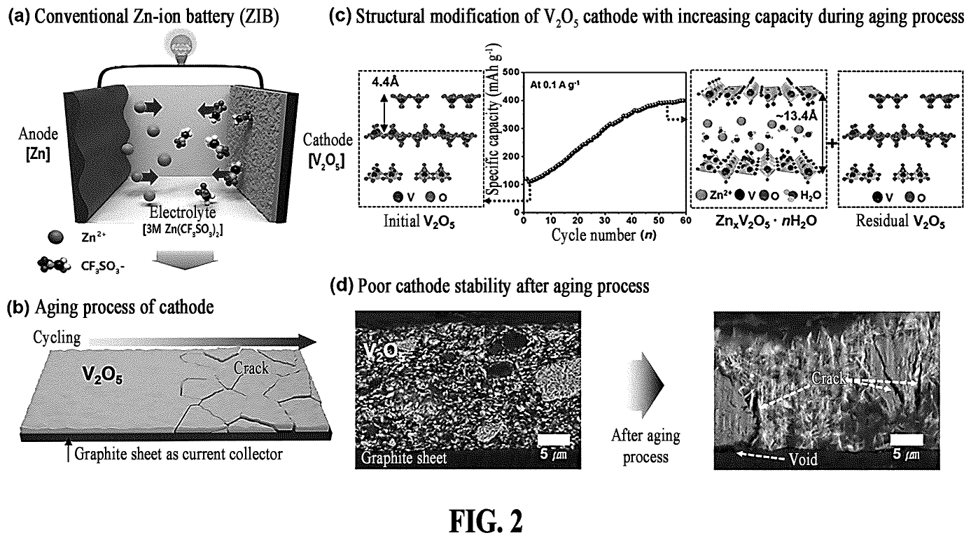

FIG. 2 is a diagram schematically illustrating (a) a Zn-ion battery (ZIB) of the related art, (b) an aging process of a ZIB cathode, (c) a structural modification of a vanadium oxide (V₂O₅) cathode with increasing capacity during the aging process, and (d) poor stability of a ZIB cathode after the aging process.

A diagram of a composition of ZIBs of the related art consisting of a V₂O₅ cathode, a Zn foil anode, a 3 M Zn(CF₃SO₃)₂ electrolyte, and a glass fiber separator is shown in FIG. 2A. A main energy storage reaction of ZIBs involves the insertion of Zn²⁺ into the cathode during cycling. However, the cracking of the cathode (FIG. 2B) due to structural modification caused by large volume expansion of V₂O₅ during cycling (FIG. 2C) leads to an unstable capacity behavior. In detail, the intercalation of Zn and H₂O into the V₂O₅ interlayers leads to a continuous increase in the capacity of the cathode during cycling owing to the structural modification of V₂O₅ due to the large volume expansion. Thus, several studies have investigated an aging process of V₂O₅ cathode for ZIBs. However, due to the cracking and voiding of electrodes, the aging process does not enable the full utilization of the electrode potential, as shown in FIG. 2D. Therefore, it is essential to develop an advanced strategy without an aging process that may maximize the efficiency of the V₂O₅ cathode to obtain high-performance ZIBs.

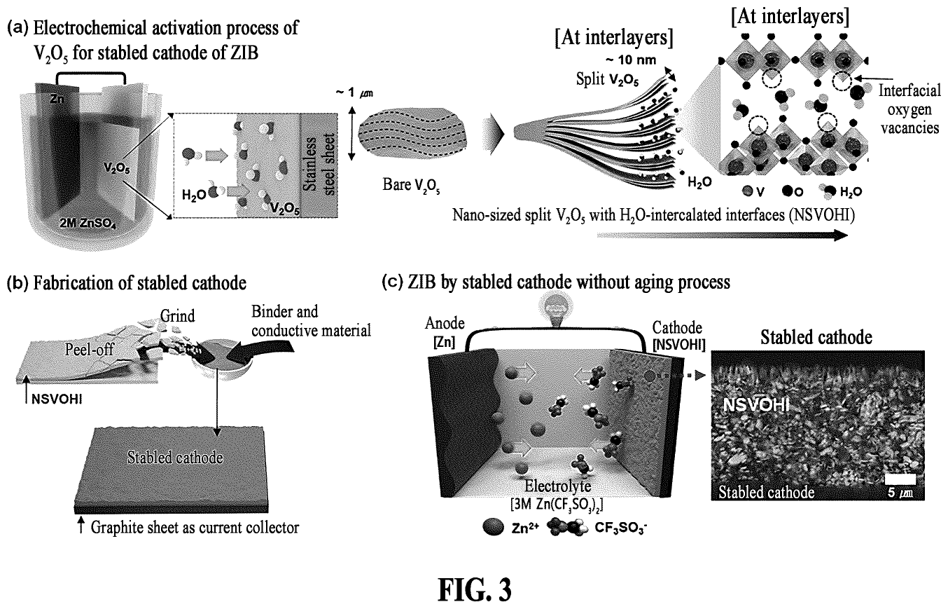

FIG. 3 is a schematic diagram of (a) an electrochemical activation process, (b) fabrication of a stabled cathode, and (c) a ZIB assembled using the stabled cathode without an aging process according to an embodiment of the present disclosure.

A schematic diagram of an electrochemical activation process used to prepare V₂O₅ as a stable cathode for ZIB is shown in FIG. 3A. For the electrochemical activation process, a charge and discharge test was conducted using bare V₂O₅ on a stainless steel foil as a working electrode, Zn foil as a counter electrode, and 2 M ZnSO₄ as an electrolyte at a current density of 0.5 A g⁻¹ for 60 cycles to obtain the NSVOHI.

In addition, after an electrochemical activation process, a low specific capacity of 14 mA h g⁻¹ was obtained due to an absence of conductive material. A ZnSO₄ electrolyte was used instead of a Zn(CF₃SO₃)₂ electrolyte because it is inexpensive and facilitates defect engineering of V₂O₅ with Vₒ. After the electrochemical activation process, NSVOHI was separated from the stainless steel foil (FIG. 3B) and washed by NMP. The DSC results of NSVOHI indicates that there was no residual PVDF after the washing process. In addition, ICP-MS results of the bare V₂O₅ and NSVOHI indicate that Zn ions were almost absent after the electrochemical activation process.

TABLE 1

Element (mg/L)

| Electrolyte | V | Zn |
|---|---|---|
| Bare V₂O₅ | 21.37 | 0.00 |
| NSVOHI | 18.71 | 0.01 |

Subsequently, a stable ZIB cathode was successfully fabricated on a graphite sheet, which was used as a current collector, without an aging process (FIG. 3C).

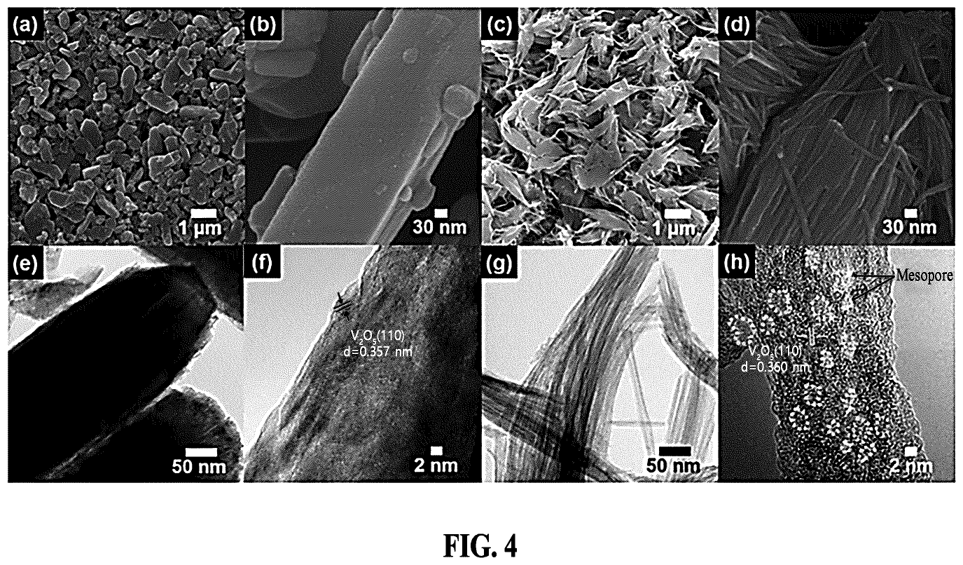

FIG. 4 illustrates a scanning electron microscopy (SEM) image and an enlarged SEM image of bare V₂O₅ (a and b), a SEM image and an enlarged SEM image of nano-sized split V₂O₅ with H₂O-intercalated interfaces (NSVOHI, c and d); high-magnification transmission electron microscopy (TEM) images of the bare V₂O₅ (e and f), and high-magnification TEM images of NSVOHI (g and h).

To examine the effect of the electrochemical activation process on the morphology of the V₂O₅, low-magnification and high-magnification SEM images of the bare V₂O₅ (FIGS. 4A and 4B) and NSVOHI (FIGS. 4C and 4D) were obtained. The bare V₂O₅ exhibited a block-like shape with diameters ranging from 1 to 3 μm (FIG. 4A). In addition, the bare V₂O₅ (FIG. 4B) exhibits a smooth surface. Accordingly, due to a smooth surface of the micro-sized V₂O₅, it may not utilize its full potential in the Zn(CF₃SO₃)₂ electrolyte due to the aging process and a long ion diffusion pathway during cycling. In contrast, the NSVOHI exhibits a chiselled surface due to the electrochemical activation process, indicating that the V₂O₅ interface was split by the H₂O-intercalation process (FIGS. 4C and 4D). The development of a split structure via the intercalation of H₂O was further confirmed in a TEM images (FIGS. 4E to 4H).

In addition, the TEM images reveals that a structure of the NSVOHI (FIGS. 4G and 4H) was entirely split with a diameter of 10 to 15 nm, whereas a micro structure with a dark contrast was observed in the TEM image of the bare V₂O₅ (FIGS. 4E and 4F). In addition, the NSVOHI exhibits a larger lattice spacing (FIG. 4H) than the bare V₂O₅ (FIG. 4F), which may be attributed to an expanded (110) interplanar spacing of the NSVOHI compared to that of the bare V₂O₅. In addition, different contrast was observed in the TEM images of the NSVOHI, indicating the formation of a mesoporous structure during the electrochemical activation process (FIG. 4H). These results indicate that the intercalation of H₂O, which split a layered structure of V₂O₅, provided an efficient ion and charge diffusion pathway via a nanosizing effect.

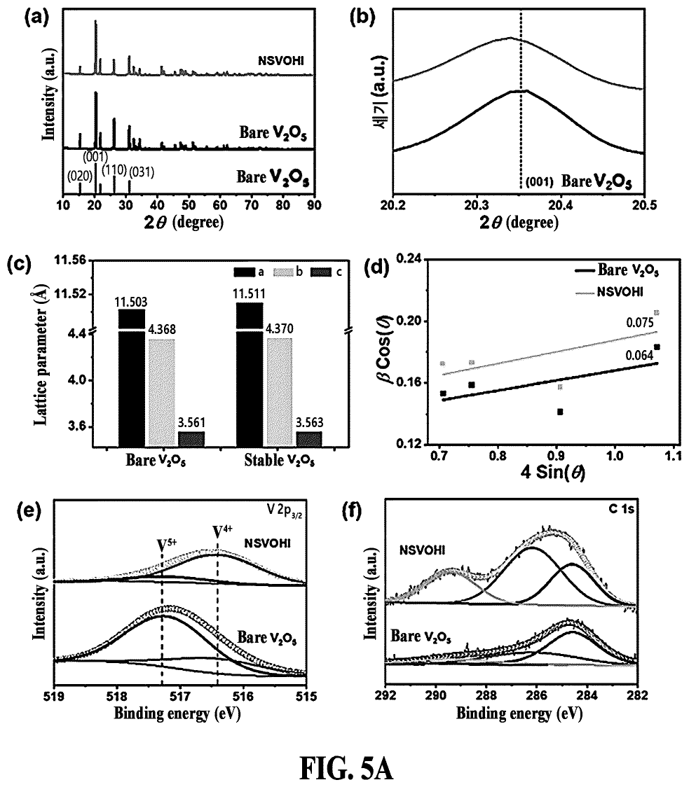

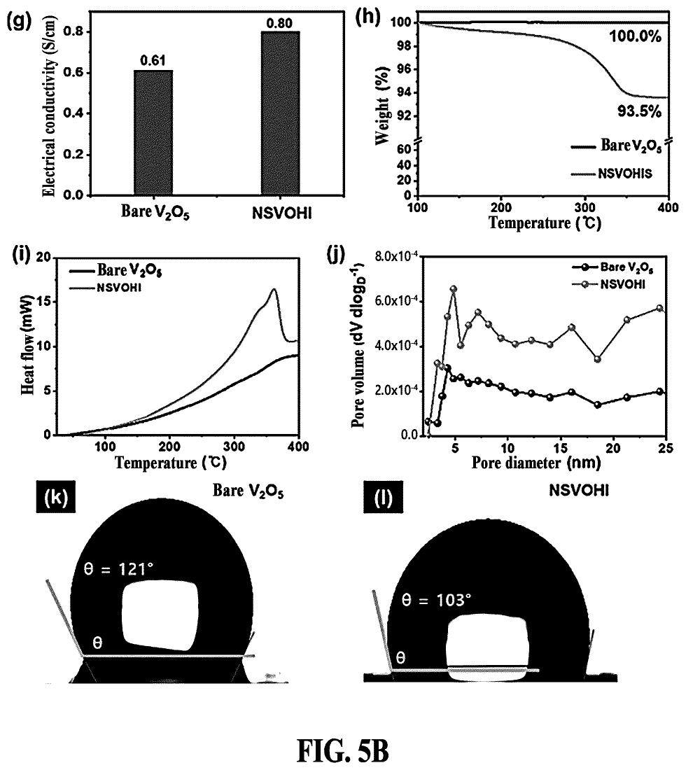

FIGS. 5A and 5B illustrates, for bare V₂O₅ and NSVOHI according to an embodiment of the present disclosure, (a) X-ray diffraction (XRD) patterns, (b) enlarged XRD patterns in a range of 20.2° to 20.5°, (c) plots of calculated lattice parameters, (d) Williamson-Hall plots, (e) V 2p_{3/2} and (f) C 1 s X-ray photoelectron spectroscopy (XPS) results, (g) electrical conductivity, (h) thermogravimetric analysis (TGA) curves, (i) differential scanning calorimetry (DSC) curves, (j) Barrett-Joyner-Halenda (BJH) results, and (k) contact angle measurement of V₂O₅ and (i) contact angle measurement of NSVOHI.

FIG. 5A shows XRD results of the bare V₂O₅ and NSVOHI. Characteristic diffraction peaks of the bare V₂O₅ were observed at 15.40°, 20.30°, 26.17°, and 31.04°, which corresponded to (020), (001), (110), and (031) planes, respectively. In contrast, diffraction peaks in the XRD pattern of the NSVOHI shift toward lower angles, indicating a specific variation of V₂O₅ lattices by the aging process (FIG. 5A). The increased lattice parameters of NSVOHI (FIG. 5C) indicate that the H₂O intercalated into the V₂O₅ interlayers induced a tensile force in the matrix. This may be attributed to the formation of H₂O between the V₂O₅ interlayers, which provided effective active sites for Zn ion storage. Furthermore, an effect on the lattice parameters on a lattice strain (e), which is related to a structural distortion, was obtained using the William-Hall method, as indicated in Equation 1:

$$β cos θ = \frac{k λ}{D} + 4 ε sin θ \qquad [ Equation l ]$$

where β is a full width at half maximum of a diffraction peak, θ is a Bragg's angle, k is a shape factor, λ is a wavelength of x-rays, and D is a grain size. As shown in FIG. 5D, the ε which is determined using a gradient of linear fit in a relationship of (β cos θ) versus (4 sin θ), of NSVOHI (0.075%) is higher than that of the bare V₂O₅ (0.064%). This further confirms that the intercalation of H₂O in the V₂O₅ interlayers expanded a lattice distance of the V₂O₅ matrix. Thus, the insertion/desertion of Zn ion during cycling is enhanced.

A chemical bonding state of the bare V₂O₅ and NSVOHI was investigated using XPS, and the results are shown in (a) and (f) of FIG. 5A. Two characteristic peaks were observed in V 2p_{3/2} XPS results ((e) of FIG. 5A) of the samples at ˜516.21 and ˜517.36, which corresponded to binding energies of V⁴⁺ and V⁵⁺, respectively, which are related to the V₂O₅ phase. An increase in the V⁴⁺/V⁵⁺ area ratio was observed on the XPS results of NSVOHI, which may be ascribed to the reduction of V⁵⁺. These results indicate that oxygen was utilized for the intercalation of H₂O into the V₂O₅ interlayers. Consequently, this improved the electrical conductivity of the electrodes due to the provision of oxygen vacancies (Vₒ), which acted as open channels for the insertion/desertion of Zn ions (FIG. 5G). In addition, the C 1 s XPS results ((f) of FIG. 5A) of the electrodes may be divided into three characteristics area, including C—C(˜284.5 eV), C—O (˜286.2 eV), and O—C═O (˜289.3 eV) peaks, indicating an increase in hydroxy groups due to the intercalation of H₂O, and this exhibited a similar trend with the presence of Vₒ, which is similar to the behavior of V⁴⁺/V⁵⁺. This suggests that the increase in Vₒ enhanced the electrical conductivity of the electrodes by supplying extra carriers for transporting electrons. A strong intensity of NSVOHI in an electron paramagnetic resonance signal is due to an increase in a concentration of paramagnetic centers, which reflects presence of Vo and modifications of localization for unpaired electrons. The compositions of the bare V₂O₅ and NSVOHI were investigated using TGA, and the results are shown in (h) of FIG. 5B. A weight loss of 0.0% was observed in the bare V₂O₅, indicating the existence of only one phase. In contrast, NSVOHI exhibits a weight loss of 6.5%, which may be attributed to the presence of the intercalated-H₂O in the V₂O₅ interlayers. Furthermore, an exothermic peak was observed in a DSC curve of NSVOHI in a range from 150.0° C. to 380.0° C., which corresponds to thermal decomposition of the intercalated-H₂O in the V₂O₅ interlayers ((i) of FIG. 5B. BJH results ((j) of FIG. 5B) reveals that the NSVOHI exhibits a type-IV isotherm curve, and a higher pore volume than the bare V₂O₅, which may be attributed to a mesoporous structure of the NSVOHI.

The BJH results indicate that the intercalation of H₂O into the V₂O₅ interfaces involves the formation of a mesoporous split structure. In addition, a specific surface area of V₂O₅ and NSVOHI exhibited 3.2 and 7.8 m² g⁻¹, respectively. Contact angle measurement is a well-known technique for characterizing a wetting characteristic of a material. The wetting characteristics of samples were investigated, and the results revealed that the contact angle (103°) ((l) of FIG. 5B) of NSVOHI ((l) of FIG. 5B) was lower than that of the exposed V₂O₅ (121°, (k) of FIG. 5B). These results clearly demonstrate the enhanced wettability of the NSVOHI, which may be attributed to the intercalation of the H₂O into the V₂O₅ interfaces, which enhanced rate performance and long-term stability of NSVOHI due to an efficient operation of the electrode-electrolyte interface. These physical/chemical results demonstrate that the optimized effect of the intercalation of H₂O into the V₂O₅ interlayers enabled the activation of the electrochemical kinetics to improve the ZIB performance in terms of the capacity, rate capability, and cycling stability.

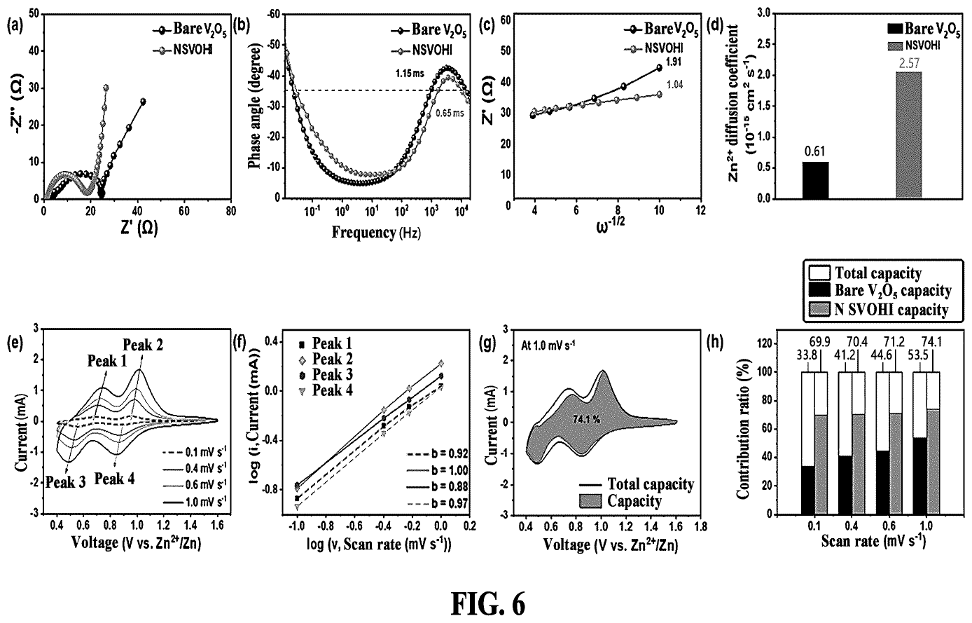

The electrochemical kinetic properties of the bare V₂O₅ and NSVOHI electrodes were investigated using EIS and CV, and the results are shown in FIG. 6.

FIG. 6 illustrates kinetic analyses of bare V₂O₅ and NSVOHI electrodes according to an embodiment of the present disclosure: (a) Nyquist plots; (b) Bode plots; (c) a correlation between Zᵣₑₐₗ and ω^{-1/2}; (d) a Zn-ion diffusion coefficient, (e) CV curves at scan rates of 0.1 to 1.0 mVs⁻¹ of the NSVOHI electrodes; (f) determination of b values of four peak currents according to a slope of log (i) versus log (v) in the CV curves; (g) capacitive behaviors and intercalation reaction contributions at 1.0 mVs⁻¹; and (h) normalized contribution ratios of capacitive storage to whole intercalation capacity at different scan rates.

The EIS Nyquist plots ((a) of FIG. 6) of the bare V₂O₅ and NSVOHI electrodes exhibited a semi-circle in the high-frequency region and a sloping line in the low-frequency region, which correspond to a charge-transfer resistance and Warburg impedance, respectively. However, the charge-transfer resistance of the NSVOHI electrode was smaller than that of the bare V₂O₅ electrode, implying an excellent charge-transfer process of the NSVOHI, which may be attributed to the improved electrical conductivity of the NSVOHI electrode resulting from the interfacial Vₒ.

In addition, the NSVOHI exhibited a lower Warburg impedance than the bare V₂O₅, implying the improved ion diffusion ability of the NSVOHI. This behavior was further examined using frequency dependence phase angle plots (Bode plots), as shown in (b) of FIG. 6, which revealed that the capacitive behavior at low frequencies may be attributed to the ion diffusion. A relaxation time constant τ₀ was calculated using the equation: τ₀=1/f₀. The τ₀ of the NSVOHI electrode (0.65 ms) was shorter than that of the bare V₂O₅ (1.15 ms), implying the improved ionic diffusion capability of NSVOHI. In addition, the Zn-ion diffusion coefficients D were calculated using Equations 2 and 3.

$${Z}_{real} = {R}_{e} + {R}_{ct} + {σ}_{w} {ω}^{\frac{1}{2}} \qquad [ Equation 2 ]$$

$$D = {R}^{2} {T}^{2} / 2 {A}^{2} {n}^{4} {F}^{4} {C}^{2} {σ}_{w}^{2} \qquad [ Equation 3 ]$$

Where Rₑ is a bulk resistance, D is an ion diffusion coefficient, R is a gas constant, T is a temperature, A is an area of an electrode, n is an electron number per molecule, F is a Faraday constant, and C is an ion molar concentration. The σ_{w} values of the bare V₂O₅ and NSVOHI electrodes were calculated using a correlation between Zᵣₑₐₗ and ω^{-1/2}, and the σ_{w} values of the bare V₂O₅ and NSVOHI electrodes were 1.91 and 1.04 Ωcm² s^{-1/2}, respectively ((c) of FIG. 6). Furthermore, the corresponding Zn-ion diffusion coefficients of the bare V₂O₅ and NSVOHI electrodes were 0.61, and 2.07×10⁻¹⁵ cm² s⁻¹, respectively ((d) of FIG. 6).

These results confirm the improved Zn-ion diffusion performance of the NSVOHI with a nano-sized split structure. To verify whether the charge-storage mechanism was dominated by a diffusion-controlled or non-diffusion-controlled process, CV measurement of the NSVOHI electrode was performed at scan rates from 0.1 to 10 mV s⁻¹, and the results are shown in (e) of FIG. 6. With an increase in the scan rates, main peaks in oxidation curves shifted to higher voltages.

In contrast, the main peaks in reduction curves shifted to lower voltages with an increase in the scan rate. The CV analysis of the peak positions was performed to quantify the contribution of the capacitive and diffusion control to a total capacity. A relationship between a peak current density (i) yield and a scan rate (v) may be estimated using: i=αv^{b}. The b values at the main cathode and anode peaks was obtained using the aforementioned equation, and the values are shown in (f) of FIG. 6. When b approaches 1.0, it suggests the dominance of the capacitive process, whereas values close to 0.5 indicate the dominance of the electrochemical diffusion-controlled process.

The b values of oxidation peaks 1 and 2 were 0.92 and 1.0, respectively, and the b values of reduction peaks 3 and 4 were 0.88 and 0.97, respectively, indicating that the charge-storage mechanism was mainly dominated by a pseudocapacitive behavior rather than an ionic diffusion process. The CV curves in (g) of FIG. 6 are separated into outstanding pseudocapacitive (k₁v) and ion-diffusion (k₂v^{1/2}) areas using the following equation:

$$i ( V ) = {k}_{1} v + {k}_{2} {v}^{1 / 2} \qquad [ Equation 4 ]$$

The results revealed that 74.1% of the entire capacity corresponded to a pseudocapacitive contribution at a scan rate of 1.0 mV s⁻¹ With an increase in scan rates, the contribution of the pseudocapacitive behavior increased to 69.9, 70.4, 71.2, and 74.1% ((h) of FIG. 6). In addition, the pseudocapacitive contribution of the NSVOHI electrode was higher than that of the bare V₂O₅ electrode at all scan rates. These results may be ascribed to: (i) the increased number of active sites due to the nano-sized split structure, (ii) improved ion diffusion ability due to expanded interplanar spacing, and (iii) enhanced electrical conductivity due to the interfacial Vₒ. Therefore, the NSVOHI electrode was expected to exhibit a remarkable energy storage performance.

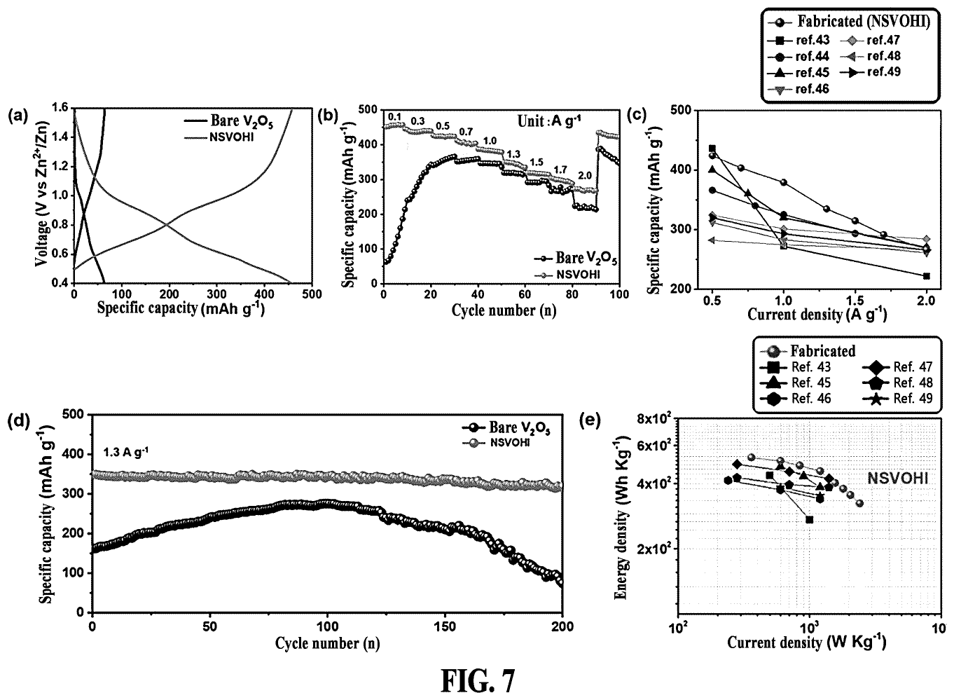

FIG. 7 illustrates electrochemical performance of ZIBs fabricated using bare V₂O₅ and NSVOHI electrodes according to an embodiment of the present disclosure: (a) charge-discharge curves; (b) rate performances; (c) comparison of the rate performances of the fabricated ZIB with those of previously-reported ZIBs; (d) cycling stability; (e) Ragone plot comparing power and energy density of a ZIB fabricated using the NSVOHI electrode with power and energy density of a previously-reported energy storage device.

To investigate the energy storage performance of the bare V₂O₅ and NSVOHI electrodes, ZIBs were fabricated using a coin-type cell, where Zn foil and 3 M Zn(CF₃SO₃)₂ were used as the anode and electrolyte, respectively. (a) of FIG. 7 shows the charge/discharge curves of the cell measured in voltage ranges from 0.4 to 1.6 V at a current density of 0.1 A g⁻¹ at the first cycle. Notable plateaus were observed during the charge and discharge process, which was similar to the trend in the CV result. In addition, the bare V₂O₅ exhibited a low discharge capacity of 63 mA hg⁻¹, whereas NSVOHI exhibited a high discharge capacity of 457 mA hg⁻¹, which may be ascribed to the smooth receptivity of the reactive Zn ions at the interfacial open channel. It is due to the H₂O intercalated into the V₂O₅ interfaces. In addition, similar charge/discharge capacities were obtained during cycling. Thus, it is further confirmed that the high Coulombic efficiency was associated with the highly reversible Zn-ion insertion/extraction process.

(b) of FIG. 7 shows the rate performance of the bare V₂O₅ and NSVOHI electrodes at current densities of 0.1 to 2.0 A g⁻¹ (indicated by the number above each step). The capacity of the bare V₂O₅ electrode increased during the initial cycles, and reached a peak after 30 cycles. This phenomenon may be attributed to the activation of V₂O₅ by Zn-ion insertion/extraction during cycling. This phenomenon restricts practical application of bare V₂O₅ electrode in battery cells for actual electronic devices. In contrast, the NSVOHI electrode showed stable and outstanding specific capacities of 457, 438, 426, 411, 386, 349, 318, 303, and 272 mA h g⁻¹ at current densities of 0.1, 0.3, 0.5, 0.7, 1.0, 1.3, 1.5, 1.7, and 2.0 A g⁻¹, respectively, and excellent recovery capacity of 434 mA h g⁻¹ at 0.1 A g⁻¹ (a capacity retention of 96%).

These results were attributed to: (i) accelerated diffusion capability of Zn-ion due to the interfacial open channels by H₂O intercalated into the V₂O₅ interfaces, and the provision of a stable state and reduced ionic diffusion pathway during cycling by the nano-sized split structure, and (ii) the enhancement of the electrical conductivity due to the presence of the interfacial Vₒ resulting from the uptake of oxygen to form H₂O at V₂O₅ interfaces. In addition, the rate performance of the NSVOHI electrode was higher than that of previously-reported ZIB electrode ((c) of FIG. 7). The long-term cycling stabilities of the bare V₂O₅ and NSVOHI electrodes for 200 cycles at a current density of 1.3 A g⁻¹ were compared as shown in (d) of FIG. 7. The NSVOHI electrode exhibited an outstanding superior capacity retention of 91%. Furthermore, at a high current density of 5.0 A g⁻¹ for 1,000 cycles, NSVOHI electrode showed good cycling stability. The outstanding long-term stability of the NSVOHI electrode was attributed to improved wettability due to the intercalation of H₂O into the V₂O₅ interfaces, which facilitated ion transfer across the electrode/electrolyte interface. In addition, the Zn(CF₃SO₃)₂ is preferred over the ZnsO₄ for electrolytes in V₂O₅-based ZIBs because it may provide high capacity due to the reduced solvent effect and decreased the number of water molecules surrounding the Zn ions. The Ragone plots revealed that the energy and power densities of the NSVOHI electrode were similar to the energy and power densities of other previously-reported ZIBs ((e) of FIG. 7). The NSVOHI electrode exhibited a maximum energy density of 395 W h kg⁻¹ at a power density of 270 W kg⁻¹, and a maximum energy density of 305 W h kg⁻¹ at a power density of 1,170 W kg⁻¹.

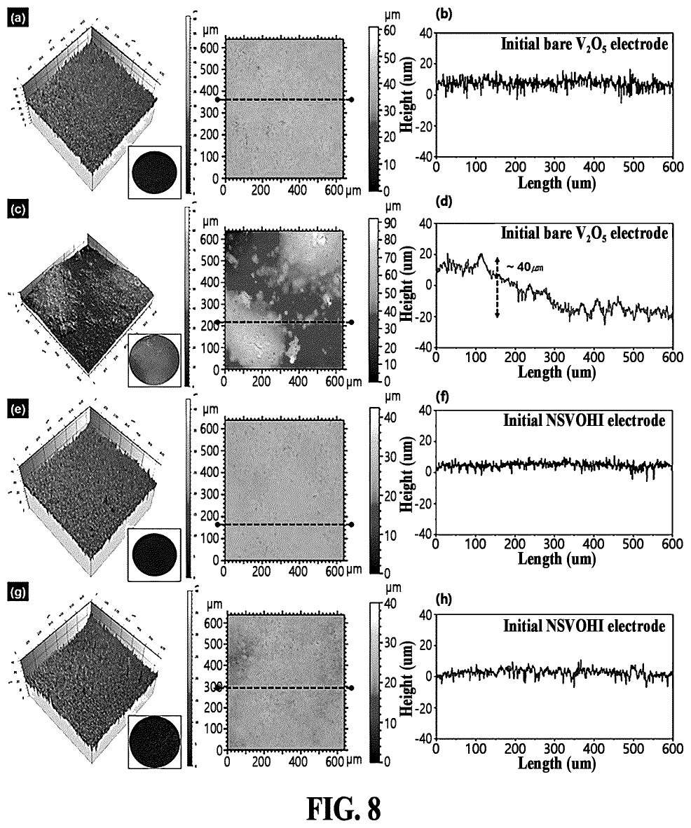

To investigate the structural stability of the ZIBs after cycling, surface properties of the bare V₂O₅ and NSVOHI electrodes were examined using a 3D surface microscope, and the results are shown in FIG. 8.

FIG. 8 illustrates three-dimensional (3D) surface images and resultant height plots of (a and b) an initial bare V₂O₅ electrode; (c and d) a cycled bare V₂O₅ electrode; (e and f) an initial NSVOHI electrode; and (g and h) a cycled NSVOHI electrode according to an embodiment of the present disclosure.

Dark images and smooth surfaces were observed in a line profile of initial bare V₂O₅ ((a) and (b) of FIG. 8) and NSVOHI ((e) and (f) of FIG. 8) electrodes. After the cycling tests, the bare V₂O₅ ((c) and (d) of FIG. 8) electrode exhibited a bright image and an uneven surface with a large-stepped cone of ˜40 μm, which may be attributed to large volume expansion resulting from the insertion/extraction of Zn ion at the V₂O₅ interlayers. In contrast, the NSVOHI ((g) and (h) of FIG. 8) electrode maintained initial color and shape with a flat surface even after cycling. These results indicate that the H₂O intercalated into the V₂O₅ interlayers effectively provided a stable condition for the insertion/extraction of Zn ion without an expansion in the volume of the electrode. Thus, the long-term stability of the ZIBs is enhanced.

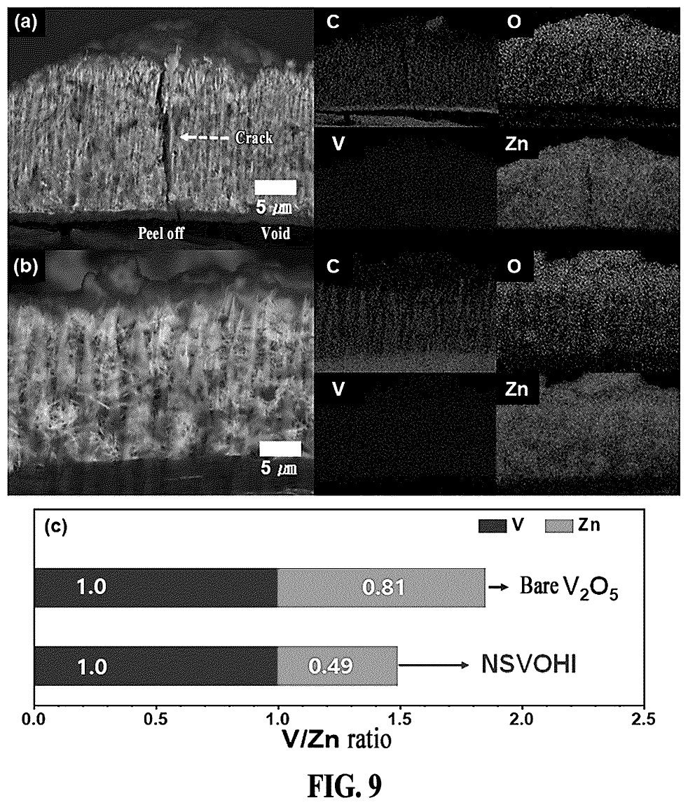

To further investigate the electrode structure after the cycling test, cross-sectional SEM images and EDS mappings were obtained as shown in FIG. 9.

FIG. 9 is diagrams illustrating reversibility of bare V₂O₅ and NSVOHI electrodes after a cycling test: cross-sectional SEM images and energy-dispersive X-ray spectroscopy (EDS) mapping of (a) a bare V₂O₅ electrode and (b) a NSVOHI electrode; (c) a ratio of Zn to V obtained from the EDS mapping.

In each image, the bright areas correspond to an electrode material with an average diameter of ˜20 μm, and the dark areas correspond to a current collector. A remarkable crack was observed in the exposed V₂O₅ electrode ((a) of FIG. 9), as well the collapse of the current collector, which may have occurred during the cycling test, due to the aging process and tensile stress. In contrast, the NSVOHI electrode ((b) of FIG. 9) exhibited a smooth surface and a stable current collector without any cracks or voids. Thus, the excellent cycling stability of the electrode was confirmed.

The reversibility of each ZIB after the cycling test was further confirmed using the Zn to V ratios obtained from the corresponding EDS mappings ((c) of FIG. 9). After the cycling tests, the NSVOHI electrode exhibited an excellent reversibility, with a Zn:V ratio of 0.49, compared to the bare V₂O₅ electrode (0.81). These results may be attributed to the stability of the NSVOHI cathode for ZIBs. Particularly, the nano-sized split structure and the H₂O intercalated in the V₂O₅ interface facilitated the efficient transfer of Zn ions and electrons between the electrode material and the current collector. These results indicate that the highly-reversible NSVOHI electrode may be applied to all-solid-state ZIBs.

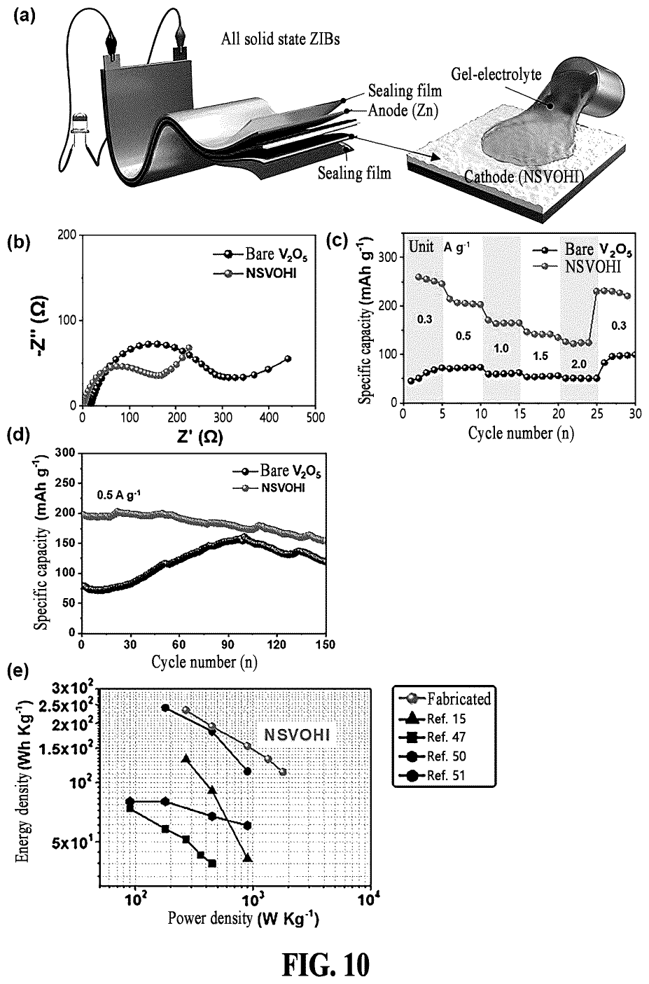

FIG. 10 is diagrams illustrating energy storage performance of an all-solid-state ZIBs consisting of a NSVOHI electrode and a gel electrolyte: (a) a schematic view of an all-solid-state ZIB structure; (b) Nyquist plots; (c) rate performance; (d) cycling stability; and (e) a Ragone plot comparing power and energy density of a ZIB fabricated using a NSVOHI electrode with power and energy density of a previously-reported all-solid-state energy storage devices.

To further investigate the potential practical application of the NSVOHI electrode, an all-solid-state ZIB was fabricated using a gel electrolyte consisting of 3.0 M Zn(CF₃SO₃)₂ and PVA as shown in (a) of FIG. 10. The use of gel electrolyte for ZIBs may guarantee strong merits, such as outstanding mechanical properties and the prevention of Zn dendrite growth, which may enhance the stability of all-solid-state ZIB under severe conditions. The electrochemical kinetic properties of the all-solid-state ZIBs were investigated using an EIS Nyquist plot as shown in (b) of FIG. 10.

The NSVOHI electrode exhibited a lower Warburg impedance than the bare V₂O₅ electrode due to its improved electrical conductivity. The rate performance of the ZIBs was tested at current densities of 0.3 to 2.0 A g⁻¹, and the results are shown in (c) of FIG. 10 (indicated by the number above each step). The NSVOHI electrode delivered specific capacities of 259, 213, 170, 146, and 125 mA h g⁻¹ at current densities of 0.3, 0.5, 1.0, 1.5, and 2.0 A g⁻¹, respectively, along with a recovery capacity of 230 mA h g⁻¹ at 0.3 A g⁻¹ (a retention rate of 88%).

Moreover, the NSVOHI electrode exhibited an excellent long-term stability for 150 cycles at a current density of 0.5 A g⁻¹ compared to the bare V₂O₅ electrode ((d) of FIG. 10). Particularly, the capacity of the bare V₂O₅ electrode increased rapidly during the initial cycling, indicating that it is unsuitable for practical applications. In contrast, the NSVOHI electrode exhibited a stable capacity behavior, indicating its excellent potential as a cathode for power supply devices. In addition, the Ragone plots revealed that the ZIB fabricated using the NSVOHI electrode exhibited a notable energy density of 233 W kg⁻¹ at a power density of 270 W h kg⁻¹, which is comparable to the energy density of previously-reported all-solid-state energy storage devices ((e) of FIG. 10).

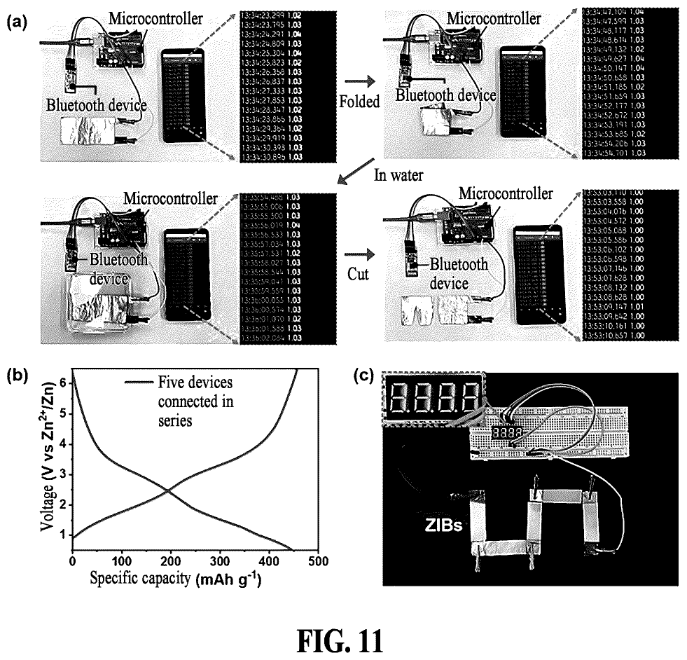

FIG. 11 illustrates investigation of practical application of an NSVOHI electrode according to an embodiment of the present disclosure: (a) photographs showing voltage conditions of a Bluetooth device, a microcontroller, and a smart phone connected to an electrode in straight, folded, and cut states even under water, (b) charge-discharge curves of five devices connected in series, and (c) a photograph showing an operation of a light emitting diode by fabricated ZIBs.

To further investigate the practical application of the ZIB fabricated using the NSVOHI electrode, a Bluetooth device, microcontroller, and smart phone were connected to the ZIB as shown in (a) of FIG. 11. The photographs confirmed that the ZIB maintained a stable voltage condition in straight, folded, and cut states, and even under water. Particularly, the charge-discharge voltages of five ZIBs, which were fabricated using NSVOHI electrodes, connected in series were approximately five times larger than an original specific capacity range ((b) of FIG. 11). Moreover, this framework successfully operated a red-light emitting diode (LED) ((c) of FIG. 11). Thus, the practical application of the NSVOHI electrode was confirmed.

In summary, the results of an embodiment of the present disclosure revealed a multifunctional effect of the electrochemical activation process of V₂O₅ on the electrochemical performance of ZIBs.

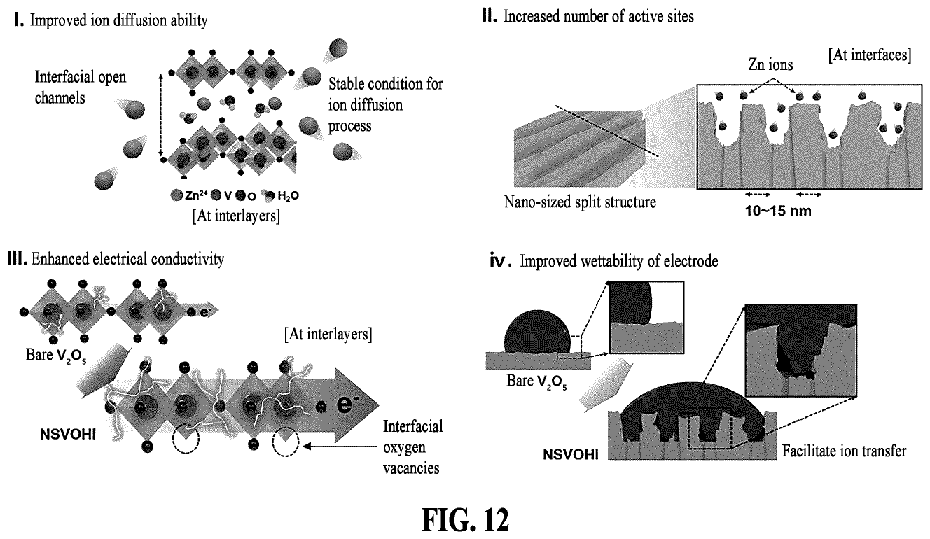

FIG. 12 illustrates schematic diagrams showing a synergetic effect of a stable ion diffusion process, an increased number of active sites, enhanced electrical conductivity, and improved wettability of a NSVOHI electrode on its the electrochemical performance.

As shown in FIG. 12, the intercalated-H₂O in the V₂O₅ interfaces expanded an interlayer distance, leading to a stable condition for the ion diffusion process. Meanwhile, the formation of a nano-sized split structure by the intercalation of H₂O into the V₂O₅ interlayers led to an increase in the number of electrochemically active sites. In addition, the supply of VO by the reduction of the V⁵⁺ sites enhanced the electrical conductivity of the electrode. Lastly, the improved wettability enabled the effective utilization of the electrode/electrolyte interface. Due to these synergistic effects, the fabricated ZIB exhibited an excellent specific capacity, a good rate performance, a superb long-term stability, and a high energy density. Furthermore, the potential practical application of the NSVOHI electrode was confirmed by preparing an all-solid-state ZIB using a gel electrolyte and the excellent mechanical flexibility and capability of operating components, such as LEDs, were confirmed.

### CONCLUSION

In this study, a stable NSVOHI was prepared as a stable cathode for ZIBs. The energy storage behavior of the NSVOHI was confirmed, as well as the synergistic effects of the stable ion diffusion process, increased number of active sites, enhanced electrical conductivity, and improved wettability of the electrode. Consequently, the NSVOHI electrode exhibited an outstanding specific capacity of 457 mA hg⁻¹ at a current density of 0.1 A g⁻¹, and a superb long-term stability of 91% for 200 cycles at current densities of 2.0 A g⁻¹ and 1.3 A g⁻¹.

These results were ascribed to the following: (i) the electrochemical activation process enhanced the ion diffusion ability and increased the number of active sites, thus enhancing the overall specific capacity of the electrode, (ii) the V⁵⁺ sites enhanced the electrical conductivity of the electrode, thus improving the rate performance, and (iii) the intercalation of H₂O into the V₂O₅ interlayer improved the wettability of the electrode by enabling the effective utilization of the electrode/electrolyte interface. Therefore, an outstanding cycling stability is provided. In addition, NSVOHI exhibited excellent structural stability and high reversibility after the cycling test, which may be attributed to the stable ion diffusion process due to the expanded interlayer distance.

Furthermore, all-solid-state ZIBs consisting of the NSVOHI electrode and a gel electrolyte were prepared, and the ZIB exhibited good electrochemical performance and excellent mechanical feasibility without a voltage fluctuation in straight, folded, and cut states, and even under water when used to operate a LED. The findings of an embodiment of the present disclosure indicate that the NSVOHI electrode may provide a promising strategy and useful insights for the design of advanced and stabled ZIBs without an aging process.

As described above, although the examples have been described with reference to the limited drawings, a person skilled in the art may apply various technical modifications and variations based thereon. For example, suitable results may be achieved if the described techniques are performed in a different order, and/or if components in a described system, architecture, device, or circuit are combined in a different manner, or replaced or supplemented by other components or their equivalents.

Therefore, other implementations, other examples, and equivalents of the claims are within the scope of the following claims.

1. A vanadium oxide-based cathode material for a zinc-ion battery, the vanadium oxide-based cathode material comprising:
nanoparticles of oxygen vacancy (Vₒ) vanadium oxide; and
water (H₂O) intercalated into lattices of the nanoparticles of the oxygen vacancy vanadium oxide.

2. The vanadium oxide-based cathode material of claim 1, wherein an interface of the vanadium oxide is split from bare vanadium oxide.

3. The vanadium oxide-based cathode material of claim 2, wherein the bare vanadium oxide has a diameter of 0.1 μm (micrometers) to 5 μm.

4. The vanadium oxide-based cathode material of claim 2, wherein the split vanadium oxide has a thickness of 20 nm (nanometers) or less.

5. The vanadium oxide-based cathode material of claim 2, wherein the split vanadium oxide has an interlayer gap of 0.1 nm to 10 nm.

6. The vanadium oxide-based cathode material of claim 1, wherein the oxygen vacancy vanadium oxide is vanadium oxide comprising interfacial oxygen vacancies.

7. The vanadium oxide-based cathode material of claim 1, wherein the nanoparticles of the vanadium oxide comprises one or more selected from a group consisting of V₂O₅, V₂O₃, V₃O₇, V₄O₇, V₅O₉, V₆O₁₁, V₆O₁₃, and V₇O₁₃.

8. A method of preparing a vanadium oxide-based cathode material for a zinc-ion battery, the method comprising:
coating a metal foil with vanadium oxide nanoparticles; and
preparing water (H₂O)-intercalated nano-sized split vanadium oxide by causing a charging and discharging reaction of a battery comprising the metal foil coated with the vanadium oxide nanoparticles as a working electrode in a full-cell condition.

9. The method of claim 8, wherein the metal foil comprises at least one selected from a group consisting of stainless steel (SUS), copper (Cu), nickel (Ni), iron (Fe), chromium (Cr), and cobalt (Co).

10. The method of claim 8, wherein the battery comprises a Zn counter electrode and a ZnSO₄ electrolyte.

11. The method of claim 8, wherein the charging and discharging reaction is performed by a charging and discharging test at a current density of 1 A g⁻¹ of 0.1 A g⁻¹ during 30 cycles to 100 cycles.

12. The method of claim 8, further comprising:
after preparing the water (H₂O)-intercalated nano-sized split vanadium oxide,
separating the water (H₂O)-intercalated nano-sized split vanadium oxide from the metal foil;
forming a mixture by mixing a pulverized powder of the separated water (H₂O)-intercalated nano-sized split vanadium oxide with a binder and a conductive material; and
forming the mixture on a current collector.

13. A zinc-secondary battery comprising:
a cathode comprising the vanadium oxide-based cathode material for the zinc-ion battery of claim 1;
an anode for the zinc-ion battery;
a separator interposed between the cathode and the anode for the zinc-ion battery; and
an electrolyte.
